(19) United States
(12) Patent Application Publication
(10) Pub. No.: US 2025/0011105 A1
(43) Pub. Date: Jan. 9, 2025

(54) DEVICE FOR MANAGING THE LOADING OF TRANSPORT UNITS OF A CONVEYOR SYSTEM

(71) Applicant: FERAG AG, CH-8340 HINWIL (CH)

(72) Inventor: Roberto FENILE, Wetzikon (CH)

(73) Assignee: FERAG AG, CH-8340 HINWIL (CH)

(21) Appl. No.: 18/712,321

(22) PCT Filed: Nov. 24, 2022
(86) PCT No.: PCT/IB2022/061381

§ 371 Date: May 22, 2024

(30) Foreign Application Priority Data
Nov. 29, 2021 (CH) CH70614/2021
Jul. 8, 2022 (CH) CH000821/2022

(51) Int. Cl. B65G 47/64; B65G 1/137

(52) U.S. Cl. CPC B65G 47/64; B65G 1/1376

(57) ABSTRACT

A station (3) for managing the load of transport units of a conveyor system includes a first conveyor (21) and a second conveyor (25) with a plurality of transport units (4, 4′, 4″); at least one transfer station (31), arranged for receiving units of goods (9), wherein the at least one transfer station (31) has a third conveyor (32) for conveying units of goods (9); a retrieval station (36) for retrieving units of goods from a transport unit (4″) of the first conveyor (21) and for transferring the retrieved units of goods to said transfer station; and a transfer station (37, 37′) for transferring units of goods from said transfer station to a transport unit (4, 4′) of the second conveyor. The first conveyor (21) and the second conveyor (25) are functionally connected by a conveyor system (10).

### BACKGROUND OF THE INVENTION

### Field of the Invention

The invention relates to stations for the load management of transport units of a conveyor system, conveyor systems and storage systems with such load management stations, as well as methods for the load management of transport units of a conveyor system.

### Discussion of Related Art

In automated warehouses, large-scale production facilities and generally in the conveying and transportation of goods, overhead conveyor systems have proven to be an efficient means of transporting, buffering and long-term storage of various types of goods. In overhead conveyor systems, the goods are either suspended directly from individual conveyor elements of a conveyor system in a suitable manner or placed in corresponding transport elements such as transport pouches, which in turn are stored suspended from the conveyor elements.

Overhead conveyor systems can be realized as transport chain systems in which a large number of conveyor elements form links in a chain that is moved along a conveying path. Gravity-driven conveyor systems are also known, in which individual conveyor elements move on corresponding rails. Such gravity-driven, rail-guided conveyor systems are known, for example, from US 2017/275826 A1, US 2018/215547 A1 and US 2017/282317 A1.

In particular the ever-increasing volumes in online retail require retailers, suppliers and logistics companies to handle the goods to be processed efficiently, especially with regard to the production, provision and storage of articles, as well as the picking and transportation of articles to the customer. Overhead conveyor systems with transport elements are particularly suitable for efficiently conveying heterogeneous units of goods, such as e.g. workpieces in production processes, spare parts, consumer goods such as books, clothes, shoes, etc. For example, in logistics centers of mail order companies, overhead conveyor systems can be used to store a large number of units of goods of different sizes and weights, and to pick groups of articles according to the respective customer orders, i.e. to compile them into groups of goods according to specifications and prepare them for dispatch.

In this description, the term “units of goods” or “goods” is used synonymously, and can include in particular individual unit loads, but also packaged goods such as parcels, and generally items that can be handled individually.

WO 2018/162123 A1 shows an exemplary method for picking units of goods in an overhead conveyor system, in which the individual goods are retrieved from a collection of goods and picked into groups of goods and made available in the form of these groups of goods for further processing. The groups of goods are compiled by placing the corresponding units of goods in an overhead conveyor pouch of an overhead conveyor system.

One aspect relevant to an overhead conveyor system is the simple, smooth and efficient insertion of units of goods into the empty transport elements, for example transport pouches, and the simple, smooth and efficient retrieval of the units of goods from the transport elements. Manual insertion of the units of goods into the transport elements or retrieval of the units of goods from the transport elements allows flexible handling of different units of goods but is slow and cost-intensive. Semi-automated or fully automated systems have been developed accordingly.

Examples of such automated loading systems and/or unloading systems for transport pouches transported in an overhead conveyor system are shown, for example, in EP 2130968 A1, US 2018/072511 A1, US 2018/0208407 A1, EP 2418160 A1, US 2019/0367282 A1, US 2021/0171292 A1, WO 2018/078098 A1, US 2017/0369250 A1 and US 2021/0053763 A1.

Conventional automated picking systems typically consist of at least one long-term storage area, one short-term storage area, if applicable, a sorting system, and a goods issue area. The various types of units of goods are stored in the long-term warehouse and kept ready for later processing. The units of goods of one or more picking orders taken from the long-term warehouse are buffered in the short-term warehouse. The units of goods of a picking order are sorted if applicable and sent to the goods issue area, where the units of goods of the completed picking order can be packed and dispatched.

Long-term storage facilities can for example be implemented as high-bay warehouses, which allow high storage volume utilization and for which highly automated access systems exist. Smaller units of goods are generally stored by type in larger storage containers, from which the necessary units of goods can be retrieved as required.

Short-term storage facilities can be realized in an overhead conveyor system with conveyor units, in particular as fast buffer storage in the form of accumulation sections or carousel storage units. In particular, this also makes it possible to realize feeding, retrieval and, if necessary, sorting processes within the overhead conveyor system.

Access times to conventional long-term storage facilities are typically long, which at high throughput rates can lead to a logistical bottleneck. Furthermore, a system interface is required between the long-term warehouse and the short-term warehouse. In the simplest case, for example, an operator retrieves a unit of goods from a storage container in the long-term storage system and transfers it to a transport unit of the overhead conveyor system.

US 2018/0251303 A1 and US 2018/0244473 A1 show a picking station for picking goods from storage containers into order containers. Box-shaped storage containers with the goods to be picked are fed from a warehouse and provided in a row of bays. An operator or a robot retrieves the necessary goods from the storage containers provided and picks them according to the order either directly into overhead conveyor pouches of an overhead pouch conveyor system (single-stage picking) or into crate-shaped storage containers, which in turn can be conveyed to a picking station (two-stage picking).

WO 2014/009138 A1 describes a system for the damage-free loading of trolleys with parcels. The parcels are fed on a horizontal conveyor and diverted to a plurality of sorting outlets aligned transversely to the horizontal conveyor, each of which comprises horizontal belt conveyors. A first group of sorting outlets, intended for heavy parcels, leads to a height-adjustable worktable. A heavy parcel is conveyed onto the worktable, which is then raised so that the parcel can be pushed horizontally onto parcels already placed on the trolley. A second group of sorting outlets, intended for light parcels, conveys the parcels overhead to a trolley to be loaded, where the parcels can fall into the trolley from above. After a trolley has been loaded with heavy parcels, it can still be completely filled with light parcels. The worktable can be moved parallel to the main conveyor so that it can be used for several trolleys. Fully loaded trolleys are removed and replaced with empty trolleys.

Long-term storage and short-term storage can also be implemented as subsystems of an overhead conveyor system. There is no need for a system interface between long-term storage and short-term storage, which makes shorter access times possible. In such a system, a unit of goods is placed in a transport unit of the overhead conveyor system and stored in a long-term storage system. Such a long-term storage system can be realized, for example, with one or more very long carousel storage units or a large number of accumulation sections and can comprise several hundred thousand overhead conveyor pouches.

The required capacity and working load of a transport unit of a conveyor system is determined by the largest or heaviest unit of goods to be stored in it. If only one type of transport unit is used, the volume efficiency and also the cost efficiency of a corresponding long-term storage system is reduced if there is a large proportion of small units of goods in relation to a few large units of goods, as the transport units are oversized or unnecessarily stable for a large proportion of the units of goods. This leads to a lower number of stored units of goods per storage volume and, due to the generally higher procurement costs for larger or more stable transport units, to a considerable increase in the overall costs of the storage system. Alternatively, different types of transport units can be used, but this makes the overall system more complex and less flexible.

There is a general need for improvement in this field of technology.

### SUMMARY OF THE INVENTION

It is an object of the invention to provide a station for managing the load of transport units of a conveyor system that does not have the above-mentioned and other disadvantages.

In particular, such a load management station shall have a small construction volume and a small footprint. It shall be energy-efficient, have a low probability of failure, be less prone to faults and require little maintenance. Production, operation and maintenance shall be cost-efficient.

It is another object of the invention to provide a method for managing the loading of transport units of a conveyor system that does not have the above-mentioned and other disadvantages.

These and other objects are solved by the elements of the independent claims. Further advantageous embodiments follow from the dependent claims and the description.

The solution according to the invention can be further improved by various embodiments, each of which is advantageous in itself, and, unless otherwise specified, can be combined with one another as desired. These embodiments and the advantages associated therewith are discussed below.

The terms “article” and “unit of goods” are used synonymously in this description and refer to separable physical objects. Containers with items packed in them can also be units of goods.

A first aspect of the invention concerns to advantageous stations for managing the load of transport units of a conveyor system.

A station according to the invention for managing the load of transport units of a conveyor system comprises a first conveyor and a second conveyor with a plurality of transport units; at least one transfer station arranged to receive units of goods, the at least one transfer station having a third conveyor for conveying units of goods; a retrieval station for retrieving units of goods from a transport unit of the first conveyor and for transferring the retrieved units of goods to said transfer station; a transfer station for transferring units of goods from said transfer station to a transport unit of the second conveyor; and a conveyor system which functionally connects the first conveyor and the second conveyor.

Advantageously, in a load management station according to the invention, the first conveyor and the second conveyor are part of a joint conveyor system.

Such an embodiment enables in particular dispensing with corresponding interfaces between different conveyor systems.

In another advantageous embodiment of a load management station according to the invention, the retrieval station is set up to retrieve all units of goods from a transport unit of the first conveyor and to transfer them to the transfer station, thereby completely emptying said transport unit.

One of the advantages of such an embodiment is that the further processing of the now empty transport unit is simplified. For example, the empty transport unit can be fed directly to a goods receipt station of a storage system for refilling, or can be transferred to the second conveyor for filling at the transfer station, or it can be transferred to a supply sector for empty transport units.

Advantageously, in a load management station according to the invention, the transfer station comprises at least one actuator for the selective movement of individual units of goods.

Such an actuator can, for example, comprise a handling device, such as a robot arm. Such a handling device has the advantage that units of goods can be manipulated as desired without complex additional devices. For example, the third conveyor can be designed as a simple linear or circular circulating horizontal conveyor on which the units of goods retrieved in the retrieval station can be deposited without further preparatory work. An actuator can also include movable elements that can move units of goods on the third conveyor, for example pushers, flipper arms, diverters and the like.

In an advantageous embodiment of a load management station according to the invention, the transport units can be conveyed on the second conveyor along a conveyor route, in particular along a conveying path. The movement of the transport units of the second conveyor is thus path-bound, which enables efficient loading of the transport unit in the load management station.

The transport units in the conveyors can be conveyed actively, by means of a drive, and/or passively, for example gravity-driven.

A load management station according to the invention can advantageously be used in a conveyor system or a storage system, for example to optimize the volume efficiency of the warehouse or the loading density of the transport units by controlling the loading of the transport units accordingly.

The first conveyor and the second conveyor are advantageously part of a joint conveyor system, in particular a conveyor system of a storage system. For example, the first conveyor and the second conveyor can be a section of a higher-level conveyor system, in particular an overhead conveyor system.

The third conveyor of the transfer station enables in particular the units of goods brought into the transfer station being efficiently sorted, transferred into transport units, combined into picking order groups, reorganized or otherwise manipulated.

A load management station according to the invention makes it possible, among other things, to retrieve units of goods from a transport unit with a low load factor and to transfer them together with other units of goods to another transport unit, which then has a higher degree of loading. In the transfer station, units of goods can also be transferred to transport units that are already loaded in order to improve the load factor of the transport unit.

A load management station according to the invention can also be used to transfer units of goods from transport units in a different composition to other transport units. In this way, for example, access times to a storage system of an order picking system can be optimized by storing frequently requested combinations of articles in orders already in the same transport unit.

It is also possible to use a load management station according to the invention to provide a frequently ordered article in a transport unit essentially sorted by type. After the transport unit has been retrieved from the long-term storage system, the units of goods are gradually retrieved from the transport unit in order to compile picking orders, and it can then be partially or completely emptied and loaded otherwise. As the corresponding retrieval processes on average take place at short intervals due to the high turnover of the corresponding article, the transport unit can remain in the short-term storage system for this period. This increases the access time to frequently requested article types without unnecessarily blocking the capacity of the short-term storage system.

In turn, item types that are rarely in demand can be placed together in a transport unit. The corresponding transport unit can then be stored in the long-term storage system with a high load level until the next article demand.

A load management station according to the invention also allows simpler and more flexible feeding of new units of goods into a storage system. When goods are received, articles can be placed in the transport units provided without having to comply with special rules. This means that units of goods can be fed into a storage system very quickly. The load management of the transport units is then carried out by means of a load management station according to the invention.

A load management station according to the invention can also be used to transfer the units of goods of a picking order, or a subset thereof, to a transport unit. This can then be conveyed to a separate goods issuing station. With such a system, the compilation of picking orders can be decoupled from the goods issue without the need to collect large quantities of transport units assigned to the picking order, each with only one article, in dedicated buffer stores, as is known from the prior art.

Advantageously, the first conveyor and/or the second conveyor of a load management station according to the invention is designed as a belt conveyor, tray conveyor, tilting tray conveyor, plate chain conveyor, modular belt conveyor, cam chain conveyor or cross-belt conveyor, or as an overhead conveyor system, in particular as a rail-guided conveyor system or as a conveyor chain system, with which transport units can be transported suspended along a conveyor route or a conveying path, respectively.

Belt conveyors, tray conveyors, tilting tray conveyors, plate chain conveyors, modular belt conveyors, cam chain conveyors and cross belt conveyors are particularly advantageous for transport units in the form of containers as described in the following embodiment. Overhead conveyor systems, on the other hand, are particularly advantageous for transport units in the form of overhead conveyor pouches.

Alternatively or additionally, in a load management station according to the invention, the first conveyor and/or the second conveyor can have a container that is open at the top when filled for holding units of goods, for example a pouch, a tray, a transport box, a basket, a crate or a cardboard box.

In this way, for example, an order picking system can be realized with a box-based high-bay storage system that is connected to a belt conveyor system that interacts with a load management station according to the invention.

In an advantageous variant of a load management station, the first conveyor and/or the second conveyor can comprise an actively driven conveyor device.

Advantageously, in a load management station according to the invention, the third conveyor comprises a device for horizontally conveying units of goods, for example a belt conveyor, tray conveyor, tilting tray conveyor, plate chain conveyor, modular belt conveyor, cross belt conveyor, vibration conveyor, cam chain conveyor, drop flap conveyor and/or a carousel conveyor.

One of the advantages of a horizontal conveyor is that the units of goods conveyed on it are accessible from above, for example for manipulators or detection devices.

In such a load management station, the transfer station particularly advantageously comprises a device for diverting units of goods on the horizontal conveyor of the third conveyor.

Deflection devices allow units of goods to be moved in a targeted manner during transportation by the horizontal conveyor so that they can, for example, reach the desired transport unit or be collected for the compilation of a picking order.

In a further advantageous embodiment of a load management station according to the invention, the third conveyor comprises a device for vertically conveying units of goods, for example a circulating paternoster conveyor.

A vertical conveyor of this type has the advantage of a smaller footprint.

In another advantageous embodiment of a load management station according to the invention, the transfer station has one or more transfer points.

For example, groups of units of goods can be collected at such transfer points before they are transferred together to a transport unit. Alternatively, transport units can be temporarily kept statically available at such transfer points so that the units of goods can be continuously transferred to the transport units.

A load management station according to the invention can comprise a device which is adapted to sort and/or group and/or separate units of goods in the transfer station.

A load management station according to the invention can comprise one or more further conveying devices, in particular passive conveying devices, for example chutes and drop chutes. Transport units or units of goods can be conveyed on such passive conveying devices without an active drive, for example gravity-driven.

A load management station according to the invention can further comprise a detection device for determining the position of units of goods in the transfer station.

Such a detection device allows easier and more efficient manipulation of the units of goods on the transfer station, since a control unit of the load management station according to the invention can take into account the current position of the units of goods for the operation of the station.

A load management station according to the invention may further comprise an identification device for determining the identity of units of goods in the transfer station.

Such an identification device makes it possible to identify units of goods on the transfer station or to verify their identity, in order to avoid or correct incorrect processes, for example. Identification can be carried out optically, for example, or by reading information carriers such as one-or two-dimensional barcodes or RFID tags.

A load management station according to the invention can also comprise a marking device for marking the position of units of goods in the transfer station.

Such a marking device can be realized, for example, with a projector or with a steerable laser beam, with which a certain unit of goods on the third conveyor is optically marked, for example by the projected image of a circle or cross. It is also conceivable to arrange a large number of lighting elements, for example LEDs arranged in a grid, on the third conveyor, which can be controlled in such a way that only the lighting elements directly around the object to be marked light up. It is also conceivable to have a number of lighting elements with a narrow light cone that cover the third conveyor in a grid pattern.

An operator can then pick up a correspondingly marked unit of goods and place it in a collection container for a picking order, for example, without having to read instructions or know the corresponding items. This increases the possible throughput speed. In addition, an operator only needs minimal training.

A load management station according to the invention can comprise a weighing device for determining the weight of one or more units of goods.

Such a weighing device can be used, for example, to verify the identity of units of goods. For example, a weighing device can be arranged under a section of the third conveyor, or elements such as transport trays of a tray conveyor can be arranged on weighing elements.

In a load management station according to the invention, the transfer station can comprise a device for the intermediate storage of units of goods.

Such intermediate storage devices increase the capacity of the transfer station and can be realized in various ways, for example as a loop of a horizontal conveyor of the third conveyor. An intermediate storage device can be permanently active, or as a buffer that can be switched on as required.

A further advantageous embodiment of a load management station according to the invention comprises at least one drop-off station for temporarily receiving and providing a group of units of goods for subsequent use, for example the packaging of the group of units of goods in a container.

In such an embodiment, a load management station according to the invention can in particular also be used as part of an order picking system. Units of goods that are required for one or more picking orders can be retrieved from the transfer station at the drop-off station. For example, the units of goods can be packed directly into shipping containers, or they can be transported to a separate goods issue station, for example using a horizontal conveyor or an automated guided vehicle (“AGV”).

Patent application CH 000821/2022 filed by the applicant on Jul. 8, 2022, entitled “Device, method and system for picking unit loads”, the disclosure of which is hereby incorporated in its entirety by reference into this description, discloses a device for picking goods. This picking device has a goods supply and comprises a) an retrieval device with at least one retrieval point for retrieving goods, and b) an retrieval handling module to which the goods are transferred by the retrieval device. The retrieval handling module comprises at least one goods receiving element and at least one movement element for transferring the goods to a downstream conveyor unit.

A drop-off station of a transfer station according to the invention can be used as a retrieval station or as a retrieval point of a retrieval station of such a picking device.

Such an advantageous embodiment of a load management station according to the invention comprises a retrieval handling module to which the units of goods are transferred from the drop-off station, wherein the retrieval handling module comprises at least one goods receiving element and at least one movement element for transferring the units of goods to a downstream conveyor unit.

In possible embodiments, a goods receiving element can be realized as a transport box, container, transport pouch, tray, shelf or as a support surface. The goods receiving elements are not limited to the embodiments listed here, and various other solutions are available to the skilled person in addition to the examples disclosed here. Preferably, however, a metallic or metal-coated support surface is used in the invention, which has a suitable static friction or sliding friction and an upward-facing outer edge so that the supplied units of goods do not slip away from the support surface unintentionally.

The units of goods are transferred from the retrieval handling module to a downstream conveyor unit. The conveyor unit then conveys the units of goods to a dispatch room and/or a forwarding point. The conveyor unit can also have goods receiving elements. In an alternative embodiment, the goods receiving elements of the retrieval handling module can be taken over by the conveyor unit.

The conveyor unit preferably comprises a mobile carrier unit and at least one manipulation device, which is arranged on the carrier unit, for handling the units of goods and/or transferring the units of goods to the dispatch room and/or forwarding point. During handling, the handling device can, for example, group the units of goods in the desired manner while they are being conveyed by the conveyor unit, or specific processing steps can be carried out, such as printing or attaching information elements to the relevant picking order or individual units of goods.

This allows the transport path to be used for such manipulation steps or processing steps, which enables an additional increase in the performance of the solution according to the invention by making the transport time after picking usable for further work steps.

For the transfer of the units of goods to the shipping area or directly to the forwarding agency, the manipulation device in the form of a deflector can preferably have active ejector elements or means for conveying away (e.g. driven rollers). Alternatively, in preferred designs, passive movement elements are also provided in at least individual manipulation devices (e.g. an inclinable transfer surface) or passive ball table surfaces, from which the units of goods are transferred to the shipping room or the forwarding agency by means that are stationary there (e.g. gripper arms or pushers).

In an advantageous embodiment, the conveyor unit is designed as an autonomous vehicle (“Automated Guided Vehicle, AGV”). One or more vehicles can operate the various retrieval handling modules during operation.

In a further advantageous embodiment, the autonomous vehicle contains an information processing unit that, depending on information generated by the control unit or by software, controls one or more retrieval handling modules and takes the units of goods from these and transports them to a dispatch room and/or forwarding point.

For example, the software-generated information can be transmitted directly to the information processing unit of the AGVs, whereby the information processing unit communicates with the retrieval handling module via the communication means and controls it intelligently.

An AGV vehicle control system includes various sensors and actuators for navigating the operating environment and for communicating with other AGVs and the retrieval handling module, or the goods feed and the retrieval device.

The sensor system of an AGV is advantageously designed to identify the conveyed units of goods and/or to identify the goods receiving elements.

The AGVs can be operated individually or with so-called swarm intelligence, whereby the latter involves a regular exchange of information between the AGVs, which leads to intelligent job allocation. Different computer structures known to the skilled person can be used here.

In addition to conveying the units of goods to the dispatch area and/or forwarding point, the conveyor unit also serves to buffer the units of goods. This additional function allows units of goods to be buffered by the retrieval handling module after being picked up by the conveyor unit before being forwarded to the dispatch area. This is useful in situations where there is a backlog of goods or a machine failure at the dispatch room and/or the forwarding point. In conventional logistics systems, a delay at the dispatch room and/or forwarding point would spread to the remaining components of the logistics system in a subsequent reaction, since buffer systems are only designed as separate devices and are not, as in the present invention, additionally enabled by the retrieval device in the form of a drop-off station of a transfer station according to the invention, the retrieval handling module and the conveyor units.

Advantageously, a conveyor unit according to the invention has elongated, fixed or movable rib elements or rib lines in the holding area for the picked units of goods in order to hold the units of goods in position along the conveyor route.

In a particularly preferred embodiment, such ribs are arranged at least around the support surface of the conveyor unit. Other alternative locking or stopping elements are known to the skilled person, in particular retaining pins, rubber coatings on the surfaces of the goods receiving elements and/or moving elements, edges of the goods receiving elements and/or moving elements that can be raised and lowered, generally referred to here as retaining means, which can be overcome by the simple application of force when the units of goods are transferred to the dispatch room and/or the forwarding point.

In special cases, the units of goods can be taken over from the retrieval handling module by a warehouse employee who transfers the units of goods directly to the forwarding point.

A load management station can be integrated into a storage system in particular in that the first conveyor and the second conveyor are part of a higher-level conveyor system of the storage system.

A second aspect of the invention concerns an advantageous conveyor system A conveyor system according to the invention comprises a load management station according to the invention.

A third aspect of the invention concerns an advantageous storage system. A storage system according to the invention comprises a load management station according to the invention.

A fourth aspect of the invention concerns advantageous methods for managing the loading of transport units of a conveyor system.

A method according to the invention for managing the loading of transport units of a conveyor system comprises the steps: p1 retrieval of at least one unit of goods from at least one transport unit of a first conveyor;
transfer of the retrieved at least one unit of goods to a transfer station (31), which comprises a third conveyor (32);
conveying at least one unit of goods in the transfer station with the third conveyor along a conveying path; and
transferring at least one unit of goods from said transfer station to at least one transport unit of a second conveyor
wherein the first conveyor and the second conveyor are functionally connected by a conveyor system.

In an advantageous variant of such a method according to the invention, the first conveyor and the second conveyor are part of a joint conveyor system. Such an embodiment variant makes it possible, in particular, to dispense with interfaces between the first conveyor and the second conveyor.

Alternatively, or additionally, in such a process, all the units of goods are advantageously retrieved from the transport unit of the first conveyor and transferred to the transfer station, thereby completely emptying said transport unit. One of the advantages of such an embodiment is that further processing of the now empty transport unit is simplified. For example, the empty transport unit can be fed directly for refilling at an incoming goods area of a storage system or transferred to the second conveyor for filling at the transfer station.

In another advantageous variant of such a method according to the invention, a subset of the units of goods is retrieved from the transfer station and is not transferred to a transport unit of the second conveyor.

In a further advantageous variant of such a method according to the invention, groups of units of goods are transferred to a transport unit of the second conveyor.

In particular, a load management station according to the invention can thus be used to compile picking orders by retrieving the corresponding units of goods from the transfer station and collecting them in a corresponding drop-off station, or alternatively, for this purpose, temporarily storing them in a specific transport unit of the second conveyor. The corresponding transport unit can then be conveyed within a storage system according to the invention to an outgoing goods station.

It is known from the mail order business in particular that the statistical distribution of the size (number of elements) of picking orders decreases disproportionately with increasing size. For example, 60% of all picking orders may comprise only one unit of goods. In such a case, a method according to the invention or a load management station according to the invention can greatly increase the efficiency for this case by collecting units of goods for such picking orders with quantity size m=1 in one transport unit. In this way, the number of transport units required for the majority of picking orders can be greatly reduced. If, for example, an average of ten units of goods can be conveyed in one transport unit, the number of transport units to be conveyed within the storage system for m=1 drops to 10%, or to 46% for all picking orders together.

A transport unit loaded with several units of goods from picking orders with m=1 can then be conveyed within a storage system to a packing station of an outgoing goods department, where an operator retrieves one unit of goods after the other from the transport unit, identifies it (for example by scanning a barcode) and packs and addresses it accordingly ready for dispatch. As all the picking orders in question contain only one unit of goods, no units of goods need to be combined in a shipping container, or the various picking orders can be separated without any further information, respectively.

This advantageous procedure can be generalized for smaller order sizes, for example by also collecting the elements of picking orders with m=2 and m=3 in a common transport unit. This can further reduce the number of transport units required. At the same time, the subsequent effort in the packing station for separating the picking orders increases. However, if the number of picking orders is kept small with m>1 per transport unit, manual separation in a packing station is still possible without any problems.

### BRIEF DESCRIPTION OF SEVERAL VIEWS OF THE DRAWINGS

For a better understanding of the present invention, reference is made below to the drawings. These merely show embodiments of the object of the invention and are not intended to limit the invention to the features disclosed herein. Identical or similar reference signs are used in the following figures and the associated description for identical or similarly acting parts.

FIG. 1 schematically shows a storage system with load management stations according to the invention in conjunction with various subsystems.

FIG. 2 schematically shows a top view of a possible embodiment of a load management station according to the invention.

FIG. 3 schematically shows a front view of a further embodiment of a load management station according to the invention, with a detection device.

FIG. 4 schematically shows a front view of another embodiment of a load management station according to the invention with a second conveyor with transport boxes.

FIG. 5 schematically shows a top view of another embodiment of a load management station according to the invention, with a robot arm as a handling device.

FIG. 6A schematically shows yet another embodiment of a load management station according to the invention, with several transfer points in a top view.

FIG. 6B schematically shows yet another embodiment of a load management station according to the invention, with several transfer points, as a cross-section viewed from the right.

FIG. 7A schematically shows a further embodiment of a load management station according to the invention, with several transfer points, in a top view.

FIG. 7B schematically shows a further embodiment of a load management station according to the invention, with several transfer points, in a side view from the right, with a collecting trough of a transfer point, in a collecting position.

FIG. 7C schematically shows a further embodiment of a load management station according to the invention, with several transfer points, in a side view from the right, with a collecting trough of a transfer point, in an emptying position.

FIG. 8 schematically shows a top view of a further embodiment of a load management station according to the invention, with several transfer points and a circulating third conveyor.

### DETAILED DESCRIPTION OF THE INVENTION

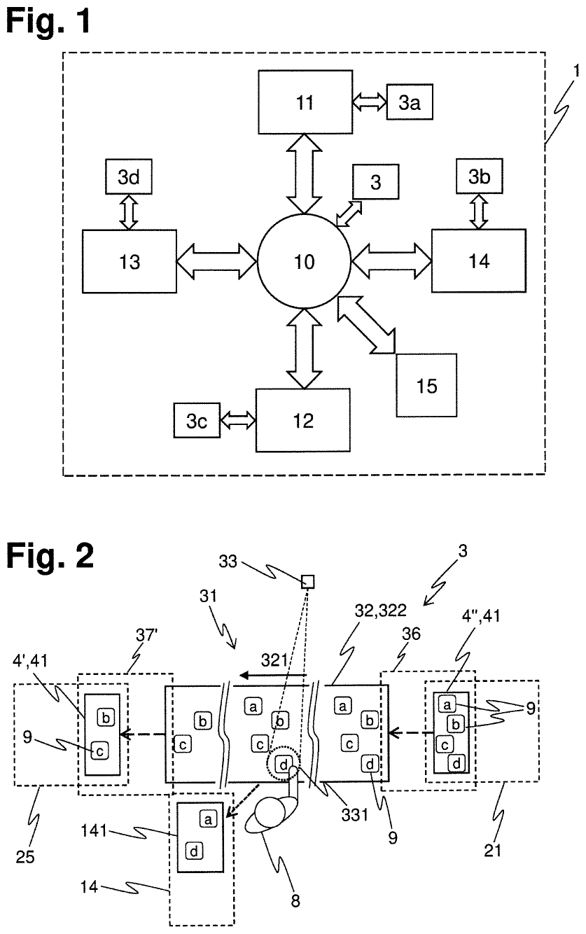

A storage system 1 according to the invention with load management stations according to the invention is schematically shown in FIG. 1. A long-term storage system 11 is designed to accommodate a large number of units of goods over a longer period of time, while a short-term storage system is designed to accommodate units of goods over shorter periods of time. Units of goods are fed into the storage system 1 via an incoming goods area 13 and retrieved from the storage system 1 via an outgoing goods area 14. An empty container storage 15 is intended to store empty, unloaded transport units and keep them ready for use. A conveyor system 10 connects these various subsystems of the storage system and enables the transportation of units of goods between the subsystems 11, 12, 13, 14, 15 of the storage system 1.

Such a storage system 1 can be used in particular in conjunction with an order picking system, with which groups of units of goods are put together according to an order and then delivered. A storage system 1 for such an application can also contain additional subsystems, for example a sorting system.

A load management station 3, 3a, 3b, 3c, 3d according to the invention is integrated into the conveyor system 10. The load management station can be assigned to a specific subsystem (load management stations 3a-3d), or can be operatively connected to two or more subsystems via the higher-level conveyor system 10 (load management station 3).

An example of a load management station 3 according to the invention is shown in FIG. 2. The load management station 3 shown is set up to compile picking orders in addition to load management.

A transport unit 4″ is fed by a first conveyor 21. This may, for example, have arrived at the first conveyor from a short-term warehouse of a higher-level storage system, may have been retrieved from a long-term warehouse 11, or may have been conveyed directly from a goods receiving area. The first conveyor 21 is only indicated by its system boundary. The first conveyor can, for example, be an overhead conveyor system with which overhead conveyor pouches 41 can be conveyed suspended as transport units. In the example shown, the transport unit 4″ comprises four units of goods 9 (marked as a, b, c, d for differentiation), whereby the units of goods can be identical or different.

At a retrieval station 36, which is also shown only symbolically as a system boundary, the units of goods 9 are retrieved from the transport unit 4″ and transferred to a transfer station 31. The transfer station 31 comprises a third conveying device 32, with which a plurality of units of goods 9 can be conveyed along a conveying direction 321. The conveyor device can, for example, be designed as a belt conveyor device with a horizontal conveyor belt 322, as shown in the figure.

The retrieval process in the retrieval station 36 can be carried out in various ways. For example, an overhead conveyor pouch 41 can be emptied onto the conveyor belt 322, or the goods units 9 can be retrieved from the transport unit and deposited on the conveyor belt 322 of the transfer station, for example by a robot arm. Preferably, the retrieval process takes place automatically. The now empty, unoccupied transport units can be transported away for further use. For example, they can be reloaded at a goods receiving area of the storage system, or they can be fed to the second conveyor of the load management station for loading. Unloaded transport units can also be temporarily stored in an empty container storage until they are used the next time.

After the units of goods a, b, c, d have been deposited on the conveyor belt 322, they are conveyed along the conveying direction 321. An operator 8 can now pick up one or more of the units of goods on the belt conveyor 32, 322 and transfer them to a drop-off station 141 of an outgoing goods department 14 to compile a picking order (in the example shown, the units of goods a and d). For example, the units of goods of an order can be temporarily deposited in a container and packed in a shipping box after the order has been compiled.

Units of goods that are not required for a picking order (b and c in the example shown) are transferred at the end of the third conveyor 32 at a transfer station 37′ (shown symbolically) to a transport unit 4′ of a second conveyor 25 (shown symbolically). The transport unit 4′ can in turn be an overhead conveyor pouch 41 of an overhead conveyor system. The transfer of the units of goods is advantageously automated.

It is possible to place units of goods that are not required into a stowed transport unit 4′ until its maximum loading capacity is reached. The maximum loading capacity can, for example, relate to the weight of the total load or to the number or volume of the stored units of goods. Combinations of such parameters are also possible. If further storage is not possible, the fully loaded transport unit 4′ is conveyed further in the second conveyor 25 and replaced by a new transport unit for receiving units of goods in the transfer station 37′.

It is also conceivable that, based on the specific combination of units of goods already stored in the transport unit 4′, a control unit of the load management station decides whether the next unit of goods can still be stored in the same transport unit or not. For example, four voluminous but light units of goods can occupy a transport unit to the maximum, or such a first unit of goods and a heavy but smaller second unit of goods, whereby in the first case the maximum loading volume is achieved and in the second case the maximum loading weight.

If different types of transport units are used in the second conveyor, for example with different maximum payloads or loading volumes, this is advantageously taken into account during load management.

It is conceivable that a transport unit 4′ kept ready in the transfer station 37′ can be loaded to its maximum capacity before it is replaced. Similarly, a transport unit 4′ kept ready can also be loaded to a lower load level before it is replaced by a new transport unit. For example, only one new unit of goods at a time can be stored in a transport unit 4′ that is kept ready. The first variant is particularly advantageous if the transport unit 4′ of the second conveyor 25 is provided statically. The number of changes of transport units in the transfer station is thus minimized, and occupied transport units are optimally filled. The last variant, in turn, is particularly advantageous in the case of a dynamically designed second conveyor, in which, for example, an empty or already partially occupied transport unit is only to be kept ready for a short time while it is filled with a unit of goods, or not, and is then conveyed further in the second conveyor. In this way, uniform loading of the transport units within the conveyor system can be achieved.

The first conveyor 21 and the second conveyor 25 are advantageously realized as part of a joint superordinate conveyor system, for example as corresponding sections of an overall conveyor of a storage system. Thus, in a particularly advantageous embodiment of a load management station according to the invention, the first conveyor 21 and the second conveyor are sections of an overhead conveyor system of a storage system whose subsystem is the load management station. Transport units 4″ are conveyed by the overhead conveyor system into a first section (which corresponds to the first conveyor 21), in which the units of goods are retrieved from the transport units and transferred to the transfer station 31. The emptied transport units are then conveyed away from the first conveyor 21 in the overhead conveyor system for further use. Similarly, transport units 4′ are conveyed from the overhead conveyor system into a second subsection 25, in which units of goods can be introduced from the transfer station 31 into the transport units 4′.

The load management station in FIG. 2 also has an optional marking device 33, which is intended to optically mark one or more units of goods on the third conveyor 32 of the transfer station 31. For example, the marking device may comprise a projector device with which a circular marking 331 is projected onto the conveyor belt 322, in the center of which a unit of goods d is located, and/or a cross-shaped marking on the unit of goods itself. The marking advantageously moves with the unit of goods moved by the third conveyor 32.

Such an optical marking 331 can be used, for example, to indicate to a human operator 8 which unit of goods must be retrieved from the transfer station 31 and made available for a picking order in the drop-off station 141. In this way, for example, instructions by means of a display on a screen can be omitted. The operator does not have to switch the focus of attention back and forth between an instruction screen and the conveyor belt, which is more convenient and increases throughput.

Instead of a projector, a controllable laser beam can also be used. A large number of statistical light sources with a narrow light cone (e.g. spotlights with a narrow focus) can also be arranged above the third conveyor 25, each of which illuminates an area of the conveyor in a grid pattern. A unit of goods can be dynamically marked by suitable control of the light sources. It is also conceivable to integrate lighting elements into the third conveyor. For example, the surface of a conveyor belt can be equipped with a matrix of light elements (e.g. LEDs), whereby the individual light elements are controlled in such a way that a specific unit of goods is visually marked for the viewer.

An optical marker can also be used with oscillating or pulsed intensity to make it easier for the operator 8 to find the marker when there are a large number of moving elements.

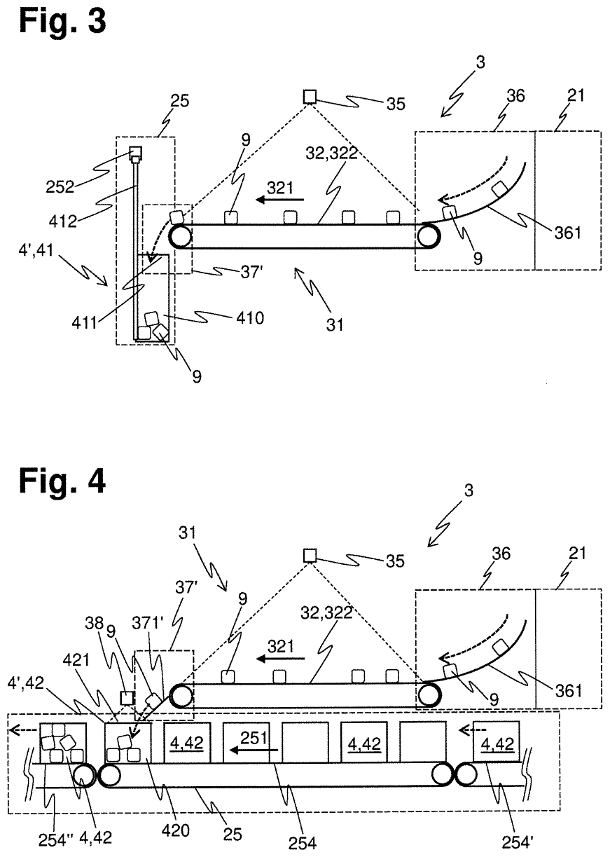

A specific further embodiment of a load management station 3 according to the invention is shown in FIG. 3. A transfer station 31 comprises a third conveyor 32 in the form of a belt conveyor 322 with a horizontal endless conveyor belt.

At a retrieval station 36, units of goods 9 pass from a first conveyor 21 with a plurality of transport units, for example in the form of a section of an overhead conveyor system with overhead conveyor pouches, via a chute 361 to the beginning of the conveyor belt 322. To empty overhead conveyor pouches of an overhead conveyor system onto a ramp 361, for example, a system such as that disclosed in US 2021/0171292 A1 can be used.

On the conveyor belt 322 of the third conveyor 32 of the transfer station 31, the units of goods 9 are conveyed along the conveying direction 321. During this transportation on the transfer station 31, the units of goods 9 can be manipulated as desired. For example, units of goods can be retrieved from the transfer station 31 and used to compile picking orders. Similarly, the sequence of the units of goods in the conveying direction 321 on the third conveyor 32 can be changed, for example, in order to be able to load a transport unit 4′ in the form of an overhead conveyor pouch 41 with units of goods as desired.

In a transfer station 37′, the units of goods 9 are transferred into a transport unit 4′ in the form of an overhead conveyor pouch 41, with a loading space 410, which is connected in a suspended manner via a support structure 412 to a free-running carriage on a running rail 252 of an overhead conveyor system or second conveyor 25. In the example shown, the transfer of the units of goods takes place in that the end of the belt conveyor 322 is arranged slightly projecting above an opening 411 of the waiting overhead conveyor pouch 41, so that a unit of goods falls into the loading space 410 after reaching the end of the third conveyor 32. If a new transport unit 4′ is to be filled, the overhead conveyor pouch 41 is guided away on the running rail 252 of the second conveyor 25 and replaced by a new transport unit.

In the shown embodiment example of a load management station 3 according to the invention, an optional detection device 35 is arranged above the third conveyor 32 in order to detect the units of goods 9 on the belt conveyor 322. The detection device 35 can, for example, be designed as a camera which records images from the top of the conveyor 35, which can then be evaluated by an evaluation unit (not shown) of the load management station in order to determine the position, orientation and/or identity of the units of goods.

A control device of a load management station can be designed in such a way that it can, for example, detect incorrect retrieval of a unit of goods from the transfer station (for example, if the incorrect unit of goods has been transferred to a goods issue or the intended retrieval has not taken place at all). In such a case, a visual or audible alarm can be triggered for the operator, for example, or the third conveyor can be slowed down or stopped. Such an embodiment has the advantage that human operating errors and malfunctions, for example of actuators, can be detected early and, if necessary, corrected before a state is reached in which rectifying the error becomes costly and difficult.

A camera of the detection device can also have a TOF (time-of-flight) 3D functionality in order to obtain data in the third dimension in addition to the two-dimensional image. A detection device 35 can also use a 3D laser scanner to create a three-dimensional image, or two cameras that are at a distance to each other. This additional 3D information can be used, for example, to determine the position of the unit of goods in space even more precisely, which makes it easier to pick it up with a robot arm, for example. The three-dimensional information can also be used to verify or check the plausibility of the identity of a unit of goods.

A load management station according to the invention can also comprise an identification device, for example an RFID sensor for reading RFID tags on the units of goods for the purpose of identifying the units of goods. It is also conceivable that three-dimensional QR codes or two-dimensional barcodes on the units of goods can be read using a camera or a laser scanner. The evaluation of images of printed data, illustrations, logos etc. on the units of goods can also be used to identify units of goods.

Another embodiment of a load management station 3 according to the invention is shown in FIG. 4. The retrieval station 36 and the transfer station 31 essentially correspond to those in FIG. 3, and reference is made to the corresponding preceding explanations. The first conveyor 21 is advantageously a box-based conveyor system analogous to the second conveyor 25 in order to avoid complex interfaces between different conveyor systems. While the units of goods 9 are being conveyed on the conveyor belt 322 of the third conveyor, the units of goods can in turn be manipulated as desired.

A second conveyor 25 comprises a sequence of belt conveyors 254′, 254, 254″ which are arranged below the third conveyor parallel to it, and on which a plurality of transport units 4, 4′ in the form of transport boxes 42 can be conveyed along a conveying direction 251 from right to left. The second conveyor can also be realized as a one-piece belt conveyor. However, the subdivision shown into several sections 254′, 254, 254″ has the advantage that the conveying speeds can be controlled differently.

In the example shown, empty transport units 4 in the form of transport boxes 42 are conveyed from the right on the belt conveyor 254′, for example from an empty container store 15. The empty transport boxes 42 are kept ready at a minimum distance on the downstream belt conveyor 254. The belt conveyor 254 thus acts as a local buffer for empty transport units.

When a unit of goods reaches the end of the conveying path of the third conveyor 32, the unit of goods passes via a chute 371′ of a transfer station 37′ into a transport unit 4′ standing ready on the belt conveyor 254, When the intended filling of this transport unit 4′ is reached, it is conveyed to the left onto the following belt conveyor 254″. At the same time, a new, empty transport unit is moved to the intended position at the transfer station 37′.

The conveying direction 251 of the second conveyor can also be reversed without further ado. In such a case, the transport boxes are conveyed from left to right. Instead of below the third conveyor, the second conveyor can also be arranged transversely to the third conveyor. It is also conceivable that the second conveyor is designed as a dead end. In such a variant, for example, the second conveyor can be filled from the left with empty, unoccupied transport boxes. The transport boxes are then filled one after the other at the transfer station 37′ and the filled transport boxes are conveyed away to the left until the second conveyor is empty.

The shown load management station 3 also has an identification device 38. The identification device 38, shown only schematically in the illustrated embodiment example, is realized as an RFID readout device, which can read out the RFID tags of the units of goods in the transport unit 4′ placed in the transfer station 37′. In this way, the identity of the units of goods stored in the transport unit can be continuously tracked and compared with the target status. In this way, incorrect loads can be detected immediately and corrected if necessary.

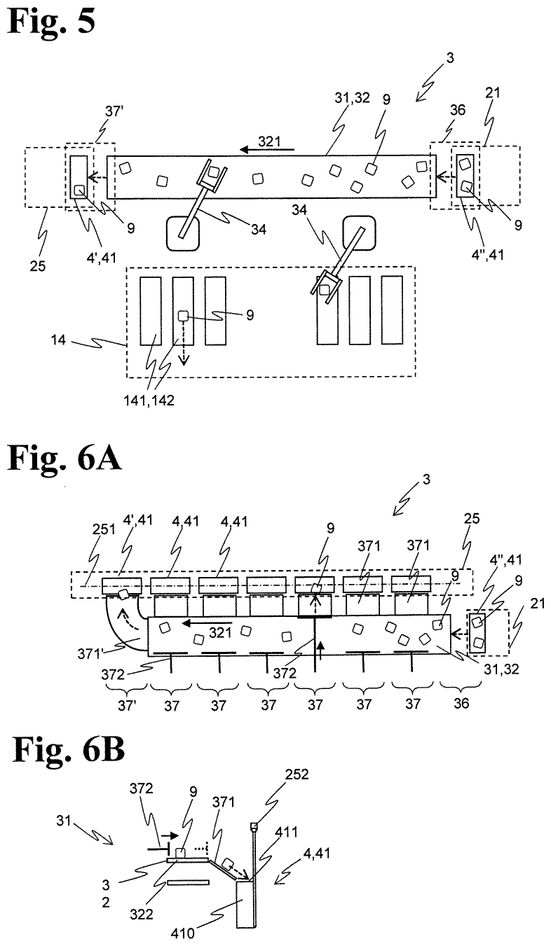

A further embodiment example of a load management station 3 with picking functionality according to the invention is shown schematically in FIG. 5. Retrieval station 21, transfer station 31 and transfer station 25 essentially correspond to the embodiment example in FIG. 2.

Instead of a human operator, two handling devices 34 are provided in the form of robot arms with grippers. These can, for example, specifically pick up certain units of goods 9 on the horizontal third conveyor 32 and deposit them in a plurality of drop-off stations 141 of a goods outlet 14 in order to compile corresponding picking orders. In the example shown, the drop-off stations are designed as chutes 142, on which the units of goods deposited thereon are gravity-driven for further processing, in particular for loading a shipping container.

An advantageous embodiment of a load management station 3 according to the invention, which enables the parallel loading of several transport units, is shown in FIG. 6. Transport units 4″ are fed by a first conveyor 21 and unloaded at a retrieval station 36. The units of goods 9 are transferred to the transfer station 31. The transfer station 31 includes a third conveyor 32 in the form of a horizontal belt conveyor 322, which conveys the units of goods away from the retrieval station 36 along a conveying direction 321. The second conveyor 25 is designed as a section of the conveying path 251 of an overhead conveyor system. Seven transport units 4, 4′ in the form of overhead conveyor pouches 41 are arranged along the conveying path 251.

Six transfer stations 37 are arranged along the third conveyor 36, and a final transfer station 37′ is arranged at the end of the third conveyor. The transfer station 37′ is equipped with a chute 371′, via which all units of goods that reach the end of the third conveyor 32 are gravity-driven into the transport unit 4′ of the second conveyor 25. The transfer stations 37 located upstream with respect to the third conveyor each have a chute 371 with a fall line transverse to the conveying direction 321. An actuator 372 in the form of a pusher is assigned to each transfer station 37, with which a unit of goods passing on the belt conveyor can be pushed onto the chute 371, on which it then slides gravity-driven into the transport unit 4 assigned to the transfer station 37.

Such a load management station 3 is suitable for loading several transport units in parallel. The changeover cycle of the transport units in the transfer stations can thus be reduced. The exchange can also be synchronized by exchanging two or more transport units at the transfer stations at the same time. For example, in the embodiment example shown, all transport units 4, 4′ can be conveyed in the conveying direction at the same time (whereby a conveying direction to the left or right is possible here) and replaced by a new group of transport units. It is also possible to convey only one or more transport units downstream and to move the remaining transport units forward by a corresponding number of places.

The conveying speed of the third conveyor can be varied, if necessary, for example to be able to push a specific unit of goods safely into a transport unit. The third conveyor can also be divided into different sections, for example as a sequence of two or more belt conveyors. By controlling the speed of the individual belt conveyors accordingly, the distance between the units of goods along the conveying path can be adjusted.

Advantageously, the first conveyor 21 is part of the same higher-level overall conveyor system as the second conveyor 25. In the embodiment example shown, the first conveyor 21 is therefore advantageously also part of the same overhead conveyor system as the second conveyor 25, and the transport units 4″ are the same overhead conveyor pouches 41.

The load management station 3 shown is also suitable for carrying out the automated load management of the transport units in parallel with an automated compilation of picking orders using the same device. For example, one or more of the transport units kept ready in the transfer stations can be assigned to one or more picking orders and used to collect the corresponding units of goods. Units of goods are transferred to other staged transport units as part of the storage system's load management. Transport units from picking orders can then be conveyed to a shipping station at goods issue, for example. Newly loaded transport units are transported to the short-term storage area in order to be available there for short-term further use, or they are stored in a long-term storage area.

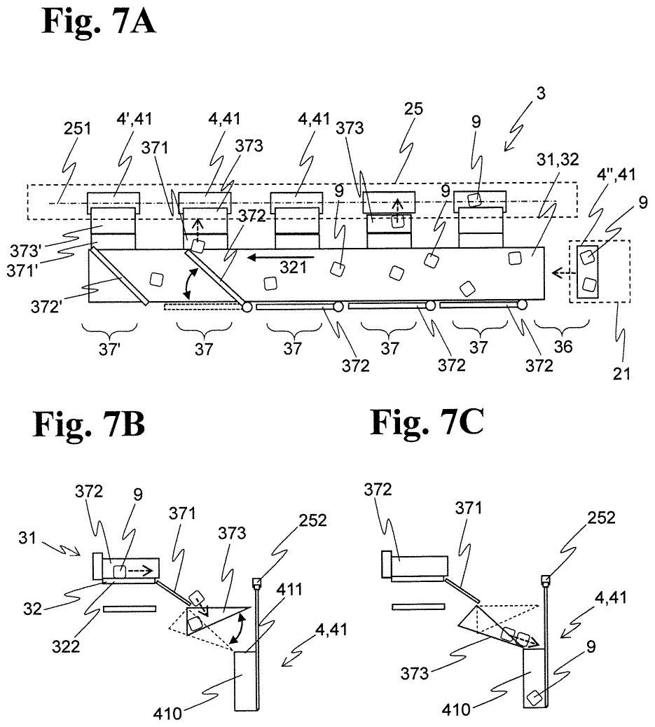

A similar embodiment of a load management station 3 according to the invention is shown in FIG. 7. In a retrieval station 21, units of goods 9 are retrieved from a transport unit 4″ of the first conveyor 21 and transferred to a transfer station 31. On the belt conveyor 322 of the transfer station 31, the units of goods 9 are conveyed along the conveying direction 321. At each of the four transfer stations 37 shown, actuators 372 in the form of pivotable deflecting elements (flippers) can divert certain units of goods onto a chute 371, which leads into a pivotably mounted collecting trough 373.

In a collecting position of the collecting trough 373 (shown in FIG. 7B), the units of goods are collected in the collecting trough 373. If the units of goods in the collecting trough 373 are to be transferred to a transport unit 4, the collecting trough 373 is pivoted into the emptying position (shown in FIG. 7C) and the units of goods slide into the loading space 410 of an overhead conveyor pouch 4, 41. The deflecting element 372′ at the end of the belt conveyor 322 need not be designed to be pivotable, but can remain permanently in the deflecting position. All remaining units of goods are guided via the chute 371′ into the swivel-mounted collecting trough 373′.

Such an embodiment of a load management station 3 according to the invention has the additional advantage that the compilation of the loading of a transport unit can be decoupled from the presence of a transport unit. Transport units of a second conveyor can, for example, be conveyed slowly past the collecting troughs 373, 373′. If a transport unit to be loaded passes a transfer station 37, 37′ whose units of goods are to be transferred to the transport unit, the collecting trough 373 is tilted into the emptying position and the units of goods slide into the loading space 410 of the transport unit. The transport unit only needs to be stopped briefly or not at all.

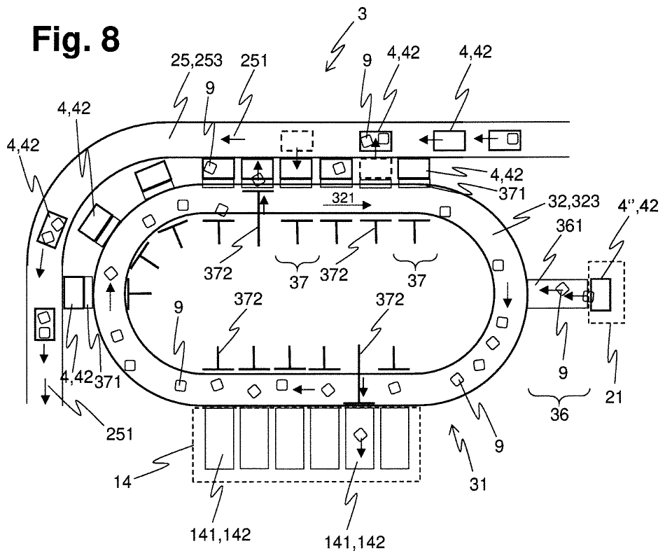

Yet another embodiment of a load management station 3 according to the invention is shown in FIG. 8, in which the first conveyor 21 and the second conveyor 25 are designed as part of a crate-based conveyor system.

A transport unit 4″ in the form of a transport box 42 is fed by a first conveyor 21 and its contents are transferred to the transfer station 31 at a retrieval station 36. The transport boxes 42 can be conveyed in the first conveyor analogous to the second conveyor discussed below on a modular belt conveyor, but also with another suitable conveying means, for example a cam chain conveyor. Using a suitable actuator device (not shown), the transport box 4″, 42 can then be emptied onto a chute 361, for example, on which the units of goods 9 slide gravity-driven onto the third conveyor 32 of the transfer station 31.

In the embodiment example shown, the second conveyor 25 is designed as a modular belt conveyor 253, on which the transport boxes 4, 42 can be moved within the load management station 3. Transport boxes can be fed from a higher-level, box-based storage system, if necessary via suitable interfaces, or transferred back into the storage system.

The third conveyor 32 is designed as a circulating modular belt conveyor 323, which conveys the units of goods in the transfer station 31 in the conveying direction 321 clockwise along a closed conveying path. The modular belt conveyor transports the units of goods 9 past an optional goods outlet 14 with a plurality of discharge stations, at which certain units of goods can be pushed from the third conveyor onto a conveyor device 142 of a discharge station 141 by means of actuators in the form of pusher devices 272. Subsequently, the third conveyor 32 conveys the units of goods 9 past nine transfer stations 37, at each of which a transport unit 4 in the form of a transport box 42 is provided. By means of actuators in the form of pusher devices 372, units of goods 9 can be moved in a targeted manner from the modular belt 322 via a chute 371 into the transport units 4, 42 provided.

Transport units 4, 42, whose filling has been completed, can be transferred to the second conveyor 25 by means of a suitable actuator device (not shown), such as a gripper, a pusher or a horizontal conveyor. Similarly, at unoccupied transfer stations 37, transport units 4, 42 are retrieved from the second conveyor 25 using a suitable actuator device (not shown) and made available for loading.

Alternatively, the second conveyor 25 can be realized as a cross-belt conveyor, for example.

A third conveyor of a transfer station can alternatively be realized in various other ways instead of as a belt conveyor or modular belt conveyor, which allow units of goods to be transferred to a specific transport unit in a targeted manner. For example, a robot arm can be used to pick up a unit of goods and deposit it in a specific transport unit. Similarly, a tilting tray conveyor, a cross-belt conveyor or a drop flap conveyor can be used as a third conveyor in the transfer station, in which the corresponding modules of the conveyor each also contain an actuator device.

A third conveyor, in particular a third conveyor with a closed conveying path, can also serve as a buffer for short-term intermediate storage of units of goods in the load management station. This can be used, for example, to stabilize the operation of a storage system. It is also possible for units of goods that will be needed in the future for filling transport units but cannot yet be filled into transport units, for example because the transfer stations are still occupied otherwise, to be left in the transfer station for a certain period of time until the corresponding transport units are ready for filling.

A load management station according to the invention can also have two or more retrieval stations instead of one retrieval station as shown in the previous examples.

The third conveyor of the transfer station of a load management station according to the invention can also consist of several sub-conveyor systems. For example, units of goods that reach the end of a linear sub-conveyor system, such as a horizontal belt conveyor, and are not transferred to a transport unit of a second conveyor, can be transferred to a further belt conveyor, for example via a transfer chute.

The third conveyor in a load management station according to the invention can also be aligned vertically instead of horizontally as described above. For example, the third conveyor can be designed in the manner of a circulating paternoster, in which horizontal cross-belt conveyor modules are conveyed vertically in a circulating manner. Such an embodiment variant can be advantageous if the footprint of a load management station according to the invention should be as small as possible.

The first and/or second conveyor of a load management station according to the invention can also be designed as a vertical conveyor. For example, overhead conveyor pouches to be loaded on a second conveyor can be conveyed vertically or with a large incline.

The present invention is not limited in its scope to the specific embodiments described herein. Rather, in addition to the examples disclosed herein, various further modifications of the present invention, which also fall within the scope of protection of the claims, will be apparent to those skilled in the art from the description and the accompanying figures. In addition, various references are cited in the description, the disclosure of which is hereby incorporated by reference into the description in its entirety.

1. A station for managing the load of transport units of a conveyor system, comprising:
a first conveyor and a second conveyor with a plurality of transport units;
at least one transfer station, arranged for receiving units of goods, wherein the at least one transfer station has a third conveyor for conveying units of goods;
a retrieval station for retrieving units of goods from a transport unit of the first conveyor and for transferring the retrieved units of goods to the transfer station;
a transfer station for transferring units of goods from the transfer station to a transport unit of the second conveyor, and
a conveyor system which functionally connects the first conveyor and the second conveyor.

2. The station according to claim 1, wherein the first conveyor and the second conveyor are part of a joint conveyor system.

3. The station according to claim 1, wherein the retrieval station is set up to retrieve all units of goods from a transport unit of the first conveyor and to transfer them to the transfer station, thereby completely emptying said transport unit.

4. The station according to claim 1, wherein the transfer station comprises at least one actuator for the selective movement of individual units of goods.

5. The station according to claim 1, wherein the transport units can be conveyed on the second conveyor along a conveyor route, in particular along a conveying path.

6. The station according to claim 1, wherein the first conveyor and/or the second conveyor comprises at least one of a belt conveyor, tray conveyor, tilting tray conveyor, plate chain conveyor, modular belt conveyor, cam chain conveyor, cross-belt conveyor, an overhead conveyor system, a rail-guided conveyor system and a conveyor chain system, with which transport units can be transported suspended along a conveyor route, or a conveying path, respectively.

7. The station according to claim 1, wherein the transport units of the first conveyor and/or of the second conveyor has a container that is open at the top in the filled state for receiving units of goods, for example an overhead conveyor pouch, a pouch, a tray, a transport box, a basket, a crate or a cardboard box.

8. The station according to claim 1, wherein the first conveyor and/or the second conveyor comprises an actively driven conveyor device.

9. The station according to claim 1, wherein the third conveyor comprises a device for horizontally conveying units of goods including at least one of a belt conveyor, tray conveyor, tilting tray conveyor, plate chain conveyor, modular belt conveyor, cross belt conveyor, vibration conveyor, cam chain conveyor, drop flap conveyor and a carousel conveyor.

10. The station according to claim 9, wherein the transfer station comprises a device for diverting units of goods on the horizontal conveying device of the third conveyor.

11. The station according to claim 1, wherein the third conveyor comprises a device for vertically conveying units of goods, for example a circulating paternoster conveyor.

12. The station according to claim 1, wherein the transfer station comprises one or more transfer points.

13. The station according to claim 1, comprising a device adapted to sort and/or group and/or separate units of goods in the transfer station.

14. The station according to claim 1, wherein the load management station comprises at least one or more further conveying devices, passive conveying devices, chutes, and drop chutes.

15. The station according to claim 1, comprising a detection device for determining the position of units of goods in the transfer station.

16. The station according to claim 1, comprising an identification device for determining the identity of units of goods in the transfer station.

17. The station according to claim 1, comprising a marking device for marking the position of units of goods in the transfer station.

18. The station according to claim 1, comprising a weighing device for determining the weight of one or more units of goods.

19. The station according to claim 1, wherein the transfer station comprises a device for intermediate storage of units of goods.

20. The station according to claim 1, comprising at least one drop-off station for temporarily receiving and providing a group of units of goods for subsequent use, for example the packaging of the group of units of goods in a container.

21. The station according to claim 20, comprising a retrieval handling module to which the units of goods are transferred from the at least one drop-off station, wherein the retrieval handling module comprises at least one goods receiving element and at least one moving element for transferring the units of goods to a downstream conveying unit.

22. The station according to claim 21, wherein the conveyor unit comprises one or more autonomous vehicles.

23. A conveyor system comprising a load management station according to claim 1.

24. A storage system with a load management station according to claim 1.

25. A method for managing the loading of transport units of a conveyor system, comprising the steps of:
retrieving at least one unit of goods from at least one transport unit of a first conveyor;
transferring the retrieved at least one unit of goods to a transfer station, which comprises a third conveyor;
conveying at least one unit of goods in the transfer station with the third conveyor along a conveying path; and
transferring at least one unit of goods from said transfer station to at least one transport unit of a second conveyor,
wherein the first conveyor and the second conveyor are functionally connected by a conveyor system.

26. The method according to claim 25, wherein the first conveyor and the second conveyor are part of a joint conveyor system.

27. The method according to claim 25, wherein all units of goods are retrieved from the transport unit of the first conveyor and transferred to the transfer station, thereby completely emptying said transport unit.

28. The method according to claim 25, wherein a subset of the units of goods is retrieved from the transfer station and is not transferred to a transport unit of the second conveyor.

29. The method according to claim 25, wherein a group of units of goods is transferred to a transport unit of the second conveyor.
